(19) United States
(12) Patent Application Publication
(10) Pub. No.: US 2011/0168529 A1
(43) Pub. Date: Jul. 14, 2011

(54) Belt Piece For The Transport Of Articles And/Or For Power Transmission And Method For Obtaining A Closed Loop Belt Starting From Said Belt Piece

(75) Inventors: Mauritzio Vincenzi, Cognento (Modena) (IT); Massimo Nascimbeni, Modena (IT)

(73) Assignee: VISION TECH S.R.L., Caldera di Reno (Bologna) (IT)

(21) Appl. No.: 13/057,672

(22) PCT Filed: Aug. 5, 2009
(86) PCT No.: PCT/IB2009/006468

§ 371 Date: Feb. 4, 2011

(30) Foreign Application Priority Data
Aug. 7, 2008 (IT) BO2008A 000514

(51) Int. Cl. F16G 3/10; F16G 3/00; F16G 1/14; B23P 11/00

(52) U.S. Cl. 198/844.2; 474/253; 29/428; 156/137; 29/525.01

(57) ABSTRACT

Belt piece, of the type which can be closed as a loop and usable for the transport of articles and/or for power transmissions, which comprises a central body (80) and two restrainable ends (2), (3), which: extend in parallel to the longitudinal axis of the belt piece (1); have transverse dimensions smaller than the ones of the central body (80); and at longitudinal sides (81), (82) have complementary coupling profiles (4), (5) comprising a plurality of first (6) and second portions (7). These portions are arranged in mutual contact when the ends (2), (3) are coupled and press the one against the other in case a longitudinal traction effort is applied to the belt piece (1), closed as a loop, to prevent the ends (2, 3) from sliding in longitudinal direction. It is further disclosed a method for obtaining a closed looped belt which uses a belt piece (1), comprising the steps of: approaching the ends (2), (3) according to a direction orthogonal to the extension one of the belt piece (1), until they are restrained; and fixing the ends (2), (3) with respect to each other by means of melting thermoplastic material or by applying small blocks.

### TECHNICAL FIELD

The present invention relates to the technical field of the belt pieces of the type which can be closed to obtain a loop by means of restraining their relative ends, and which can be employed for the transport of articles and/or for power transmissions; such belt pieces can be comprised of a toothing on a side or they can be smooth on both sides; they can be partially realized in thermoplastic material and/or they can comprise longitudinally extending stiffening cores which are buried therein.

### BACKGROUND ART

In the above-mentioned field, for example a known method for realizing closed looped toothed belts comprises the steps of: die cutting a piece of a looped toothed belt according to cutting lines such that the relative ends are given complementary coupling profiles, for example comb-shaped or V-shaped; approaching the cut ends according to a longitudinal direction with respect to the belt extension until they are brought in contact with respect to each other and are consequently restrained with respect to each other (see FIGS. 1, 2); and finally heat sealing the die cut ends.

The above-cited closed looped toothed belts are disadvantageous in that they are little resistant to traction efforts, in particular in the ends coupling region, where the belt is weakened owing to the preceding cutting and heat sealing steps. This disadvantage can be also noticed when belts with stiffening cables, which are buried therein, are employed; these cables, are in fact cut when cutting the looped toothed belt, thus being cut themselves at the coupling region.

Therefore, during the closed looped belt for the transport of articles and/or for power transmissions functioning, the coupling region is the belt section which is likely subjected to breaking.

### SUMMARY OF THE INVENTION

Therefore, it is an object of the present invention to provide a belt piece which can be employed for the transport of articles and/or for power transmissions, of the type which can be closed as a loop by means of restraining the relative ends, which belt piece is newly conceived and allows to obtain closed looped belts with improved features of resistance to traction efforts with respect to the known ones.

Yet another object of the present invention is to provide a belt piece, whose realization costs are relatively low with respect to the objects intended to be pursued.

Another object of the present invention is to provide a method for obtaining a closed looped belt starting from using a newly conceived belt piece of the above-cited type, which belt can be employed for the transport of articles and/or for power transmissions and which has improved features of traction resistance with respect to belts of known type of the field of the invention.

Yet another object of the present invention is to provide a method for obtaining a closed looped belt, whose realization costs are relatively low with respect to the objects intended to be pursued.

Said objects are obtained by means of a belt piece, which is defined in the independent claim 1, and by means of a method for obtaining a closed looped belt starting from said belt piece, as protected in the independent claim 5.

Therefore, the present invention discloses a belt piece of the type which can be closed as a loop and which can be employed for the transport of articles and/or for power transmissions, which comprises a central body and two ends, a first one and a second one, which can be coupled with respect to each other, characterized in that said first and second ends: extend in parallel to the longitudinal axis of said belt piece; have transverse dimensions smaller than the transverse dimensions of the central body of said belt piece; and at least at relative longitudinal sides, the ends have complementary coupling profiles, respectively comprising at least a first and a second portion, which are arranged in mutual contact when said ends are restrained with respect to each other and press the one against the other in case a longitudinal traction effort is applied to said belt piece, closed as a loop, to prevent the same ends from sliding in longitudinal direction.

Specific embodiments of said belt piece are defined in the claims 2 to 4.

Moreover it is disclosed a method for obtaining a closed looped belt which can be employed for the transport of articles and/or for power transmissions, of the type which employs a belt piece of the above-cited type and specifically protected in claims 1 to 4, characterized in that it comprises the steps of: restraining the cited ends of said belt piece so as to obtain a belt closed as a loop; and fixing the above-cited ends with respect to each other in order to stabilize their coupling. The following claims 6 to 10 describe specific embodiments of ways for fixing the ends by restraining.

### BRIEF DESCRIPTION OF THE DRAWINGS

The features of the invention, not emerging from the previous description, will be better highlighted in the following, according to what is claimed and with reference to the appended drawings, in which:

FIGS. 1, 2 are schematic top views of the ends of a belt piece of known type, which ends have V-shaped and comb-shaped profiles respectively, and are intended to be restrained with respect to each other according to an approaching direction, which is parallel to the longitudinal axis of the same belt piece;

FIG. 3 shows a perspective view of a toothed belt piece according to a first embodiment of the invention, whose restrainable ends are arranged the one on the other;

FIG. 4 shows again the toothed belt piece of FIG. 3, after the relative ends are restrained with respect to each other so as to obtain a closed looped toothed belt;

FIG. 5 shows a partial and enlarged top view of the closed looped toothed belt of FIG. 4, after the restrainable ends (shown in dotted lines) are fixed by thermoplastic melting, according to a first embodiment of a method, which is object of the present invention as well;

FIGS. 6, 7 show perspective views of the closed looped toothed belt of FIG. 4, after an operating step of the above-cited method according to a second embodiment;

FIG. 8 is the top view of the closed looped toothed belt of FIG. 7;

FIG. 9 is the perspective view of the closed looped toothed belt shown in FIG. 7, while another operating step of the method according to the second embodiment is carried out;

FIG. 10 is the perspective view of the enlarged detail K of FIG. 9;

FIG. 11 is the top view of the closed looped toothed belt of FIG. 9;

FIGS. 12, 13 show perspective views of the closed looped toothed belt shown in FIG. 9, after the other cited operating step of the method according to the second embodiment;

FIG. 14 shows the same perspective view as FIG. 13, in which the small blocks are shown in dotted lines in order to better show the assembling details;

FIG. 15 is the partial top view of a closed looped toothed belt according to the same scale as FIG. 5, obtained starting from a toothed belt piece (not shown) having the relative ends with dovetail-shaped profiles, according to variant of said inventive belt piece.

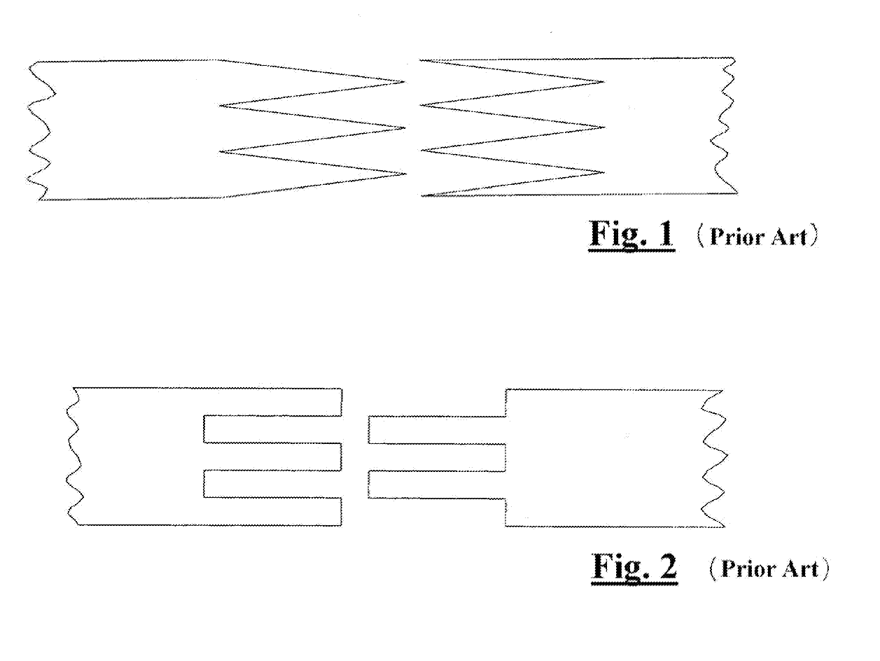

### DESCRIPTION OF PREFERRED EMBODIMENTS OF THE INVENTION

The following description specifically refers to toothed belt pieces (and closed looped belts obtained starting from these ones) realized in thermoplastic material and in which a plurality of longitudinal stiffening cores is buried similar considerations are intended for any type of belt pieces as well, which can be employed for the transport of articles and/or for power transmissions, as for example “smooth” belt pieces, i.e. pieces not provided with toothing, and/or pieces in which there are no stiffening cores.

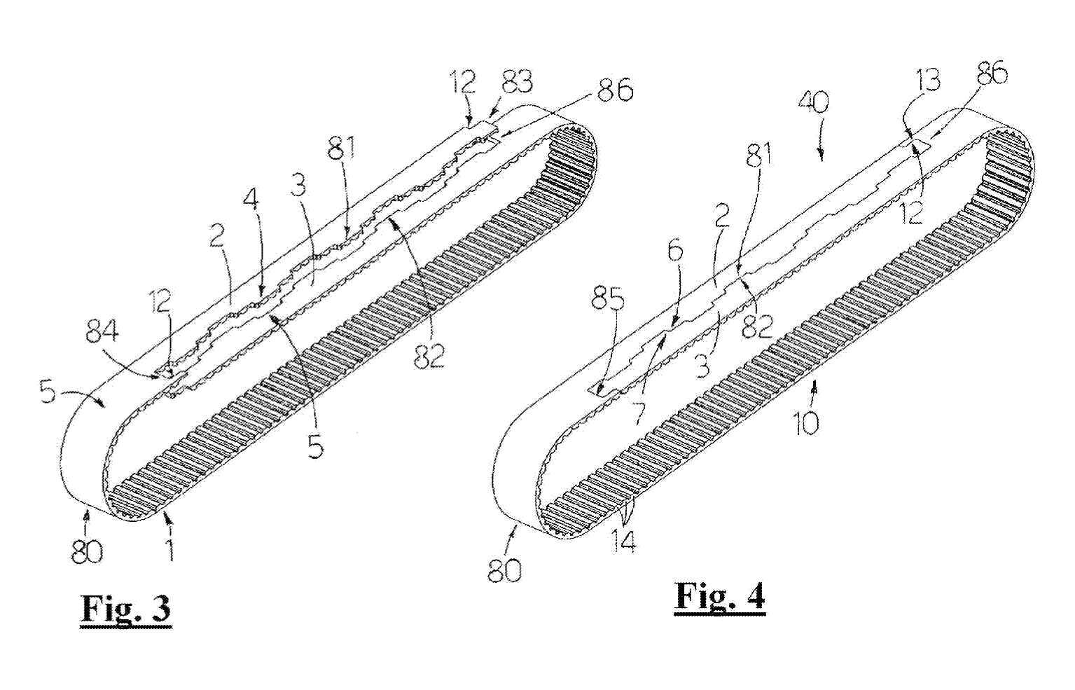

FIG. 3 shows a first embodiment of a toothed belt piece 1 according to the present invention, which comprises a central body 80 and a first 2 and a second end 3, which: have transverse dimensions smaller than the transverse dimensions of the central body 80; extend in parallel to the longitudinal axis of the toothed belt piece 1; and have complementary coupling profiles 4, 5 at respective inner longitudinal sides 81, 82 and at transverse sides 83, 84, 85, 86.

The ends 2, 3 of the belt piece 1 shown in FIG. 3 are shaped so that their restraining can be realized only according to the direction orthogonal to their extending surface S; such ends 2, 3 are approached but arranged at different heights so that their relative complementary profiles 4, 5 mutually match, if seen in top view (not shown); therefore by lowering for example the first end 2 towards the second end 3, their removable restraining is realized, see FIG. 4. As it will be better precised in the following, the thus restrained ends are stable in longitudinal and transverse direction to the extension direction of the looped toothed belt 10, thus obtained.

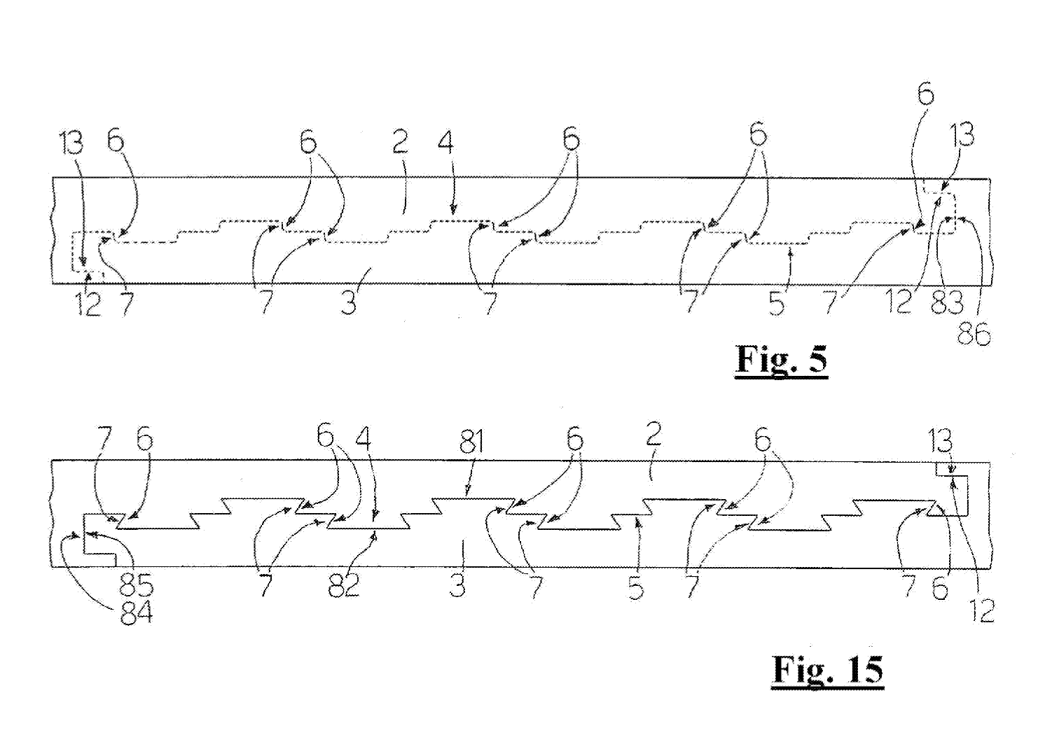

As a way of example, the restrained ends 2, 3 of the closed looped toothed belt 10 can be mutually fixed by means of local melting of respective thermoplastic material, according to techniques known to the experts in the art; therefore FIG. 5 shows a portion of the section of the closed looped toothed belt 10 of FIG. 4 after fixing by melting the ends 2, 3 (shown by the dotted line in FIG. 5).

Yet referring to FIG. 4, still prior to the local melting of the thermoplastic material, it is clear how the restrained ends 2, 3 result stable in particular in the direction of the longitudinal extension of the closed looped toothed belt 10 (in the following briefly indicated as “looped belt 10”); in other words, the ends 2, 3 are so shaped that their restraining advantageously opposes a significant resistance to longitudinal traction efforts, which the looped belt 10 can be subjected to during its normal functioning, for the transport of articles and/or for power transmissions.

In greater detail, at the inner longitudinal sides 81, 82 of the ends 2, 3, the complementary profiles 4, 5 comprise a plurality of first 6 and second portions 7, which are respectively arranged in mutual contact when the ends 2, 3 are restrained with respect to each other; and which press the one against the other in case a longitudinal traction effort is applied to the closed looped belt piece 1 (i.e. the looped belt 10). The interaction stabilizing between each couple formed by a first 6 and a second portion 7 contributes singularly to create a total resistant force opposing and compensating the traction effort, thus preventing the ends 2, 3 from sliding in longitudinal direction.

Each couple thus defined can oppose a maximum value of resistant force which depends on the configuration (shape and dimensions) of the contacting surfaces of the corresponding first 6 and second portion 7; these contacting surfaces extend transversely to the longitudinal axis of the looped belt 10. As a consequence, the maximum value of total resistant force the restrained ends 2, 3 can oppose to a traction effort in longitudinal direction depends on the total interaction of the plurality of first 6 and second portions 7.

Depending on the usages the looped belt 10 is intended to, i.e. the traction efforts it is subjected to during its functioning, it is possible to specifically design the configuration and the extension of the coupling ends 2, 3 of the belt piece 1, from which the same looped belt 10 is obtained; by varying the configuration and the longitudinal dimensions of the inner sides 81, 82 of the ends 2, 3 (and so the number of the first 6 and second portions 7, as well as shape and dimensions of the respective contacting surfaces) it is in fact possible to obtain belt pieces 1, which when closed as a loop, have determined features of resistance to the longitudinal traction efforts.

The appended drawings show clearly in this case that the longitudinal extension of the first 2 and second end 3 is a predetermined number of times greater than the transverse dimension of the belt piece 1.

A not shown embodiment of the belt piece 1 can be provided with coupling ends extending on a length greater than the dimensions of a section of the corresponding looped belt 10.

The next fixing of the ends 2, 3 of the looped belt 10 is needed to wrap the belt around pulleys, thus guaranteeing the same ends 2, 3 being stably coupled; moreover, such fixing gives the looped belt 10 more resistance to traction efforts in longitudinal direction.

Referring for example to FIG. 5, it can be noticed that the complementary profiles 4, 5 comprise patterns, always equal along the extension of the longitudinal sides 81, 82 of the ends 2, 3; once the shape of the complementary profiles 4, 5 is determined, it is thus clear that the maximum resistance to a traction effort increases with the increase of the extension of the ends 2, 3, as the number of couples of first 6 and second portions 7 of complementary profiles 4, 5 increases and so the total contacting surface on which the traction effort can be “unloaded”.

At the transverse sides 83, 84, 85, 86 of the ends 2, 3 instead, the complementary profiles 4, 5 comprise two couples, each formed by a third 12 and a fourth portion 13; said third 12 and fourth portion 13 being arranged in mutual contact respectively, when the ends 2, 3 are restrained with respect to each other and press the one against the other in case a transverse stress is applied on the closed looped belt piece 1 (i.e. looped belt 10). The above-cited considerations referring to the interactions stabilizing between couples of first 6 and second portions 7 are similarly intended, in this case, for the cited third 13 and fourth portions 13.

Specifically referring to the embodiment shown in the figures, it is clear how the above-cited couple is intended to be opposed to a transverse stress acting in a first direction, while the other couple is intended to be opposed to a transverse stress acting in the opposed direction (FIG. 5).

Therefore, the looped belt 10 obtained by restraining the two ends 2, 3 of the belt piece 1 opposes a resistance to longitudinal traction/compression efforts, to transverse stresses or to a combination of the first and second ones, i.e. to stresses acting longitudinally and transversely at the same time.

FIG. 15 shows a portion of the section of the closed looped toothed belt 10 obtained by restraining the ends 2, 3 of a belt piece according to another embodiment; in this case, the restraining is dovetail-shaped. The same above-cited considerations are intended for such a variant, therefore the same reference numbers are used.

Not shown embodiments of the inventive belt piece I can be provided with complementary profiles 4, 5 of the ends 2, 3, which do not comprise the third 12 and fourth portions 13; in such case, the restraining stabilizing between the ends 2, 3 opposes only a resistance to longitudinal traction/compression efforts applied to the closed looped belt 10.

In the following, the steps of a method, which is object of the present invention as well, for obtaining the closed looped belt 10 starting from using the above-cited belt piece 1, are described. Such method comprises the following operating steps:
approaching the ends 2, 3 of the belt piece 1 at different heights such that according to a top view of the ends 2, 3, the respective complementary profiles 4, 5 match with respect to each other;
approaching one of the ends 2, 3 of the belt piece 1 according to a direction orthogonal to the extension surface S of the same ends 2, 3 until they are restrained with respect to each other, so as to obtain the closed looped belt 10; and
fixing the ends 2, 3 with respect to each other, in order to stabilize their coupling, by means of local melting of thermoplastic material.

If the complementary profiles 4, 5 of the ends 2, 3 of the toothed belt piece I do not comprise the third 12 and fourth portions 13, the method comprises the steps of:
approaching the ends 2, 3 with respect to each other in any direction orthogonal to the longitudinal axis of the belt piece 1 (also according to a transverse direction parallel to the extension surface S of the ends 2, 3), until the ends 2, 3 are restrained; and
fixing the ends 2, 3 with respect to each other, in order to stabilize their coupling, by means of local melting of thermoplastic material.

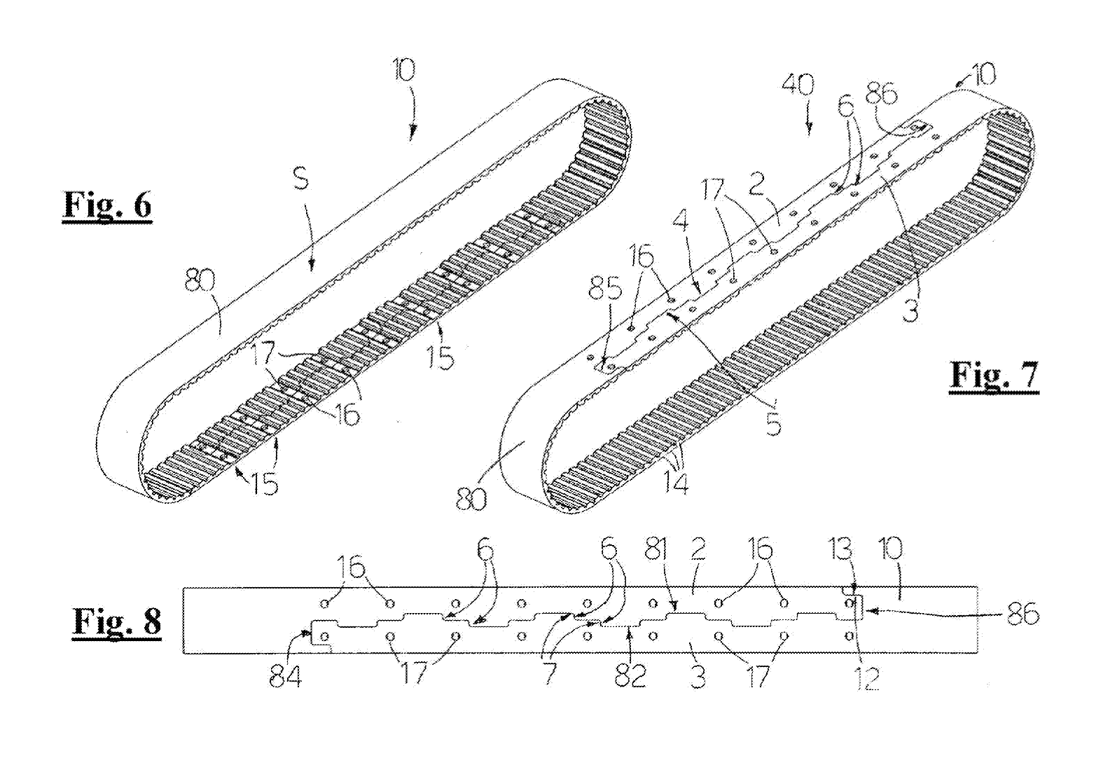

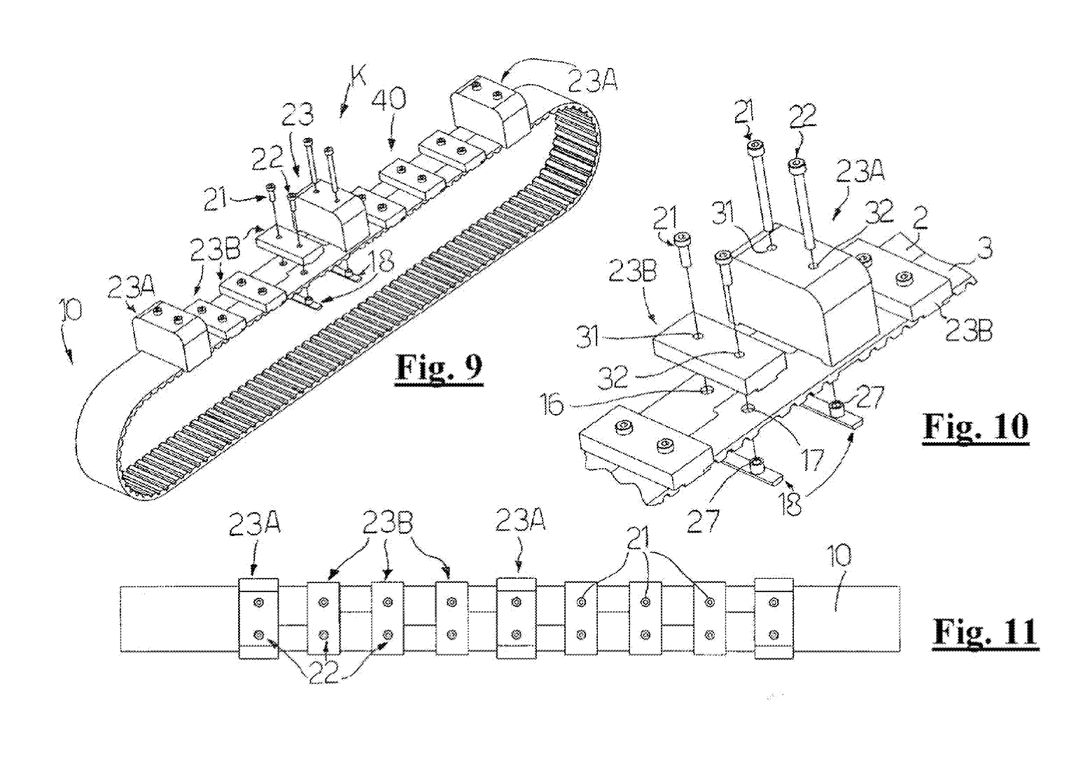

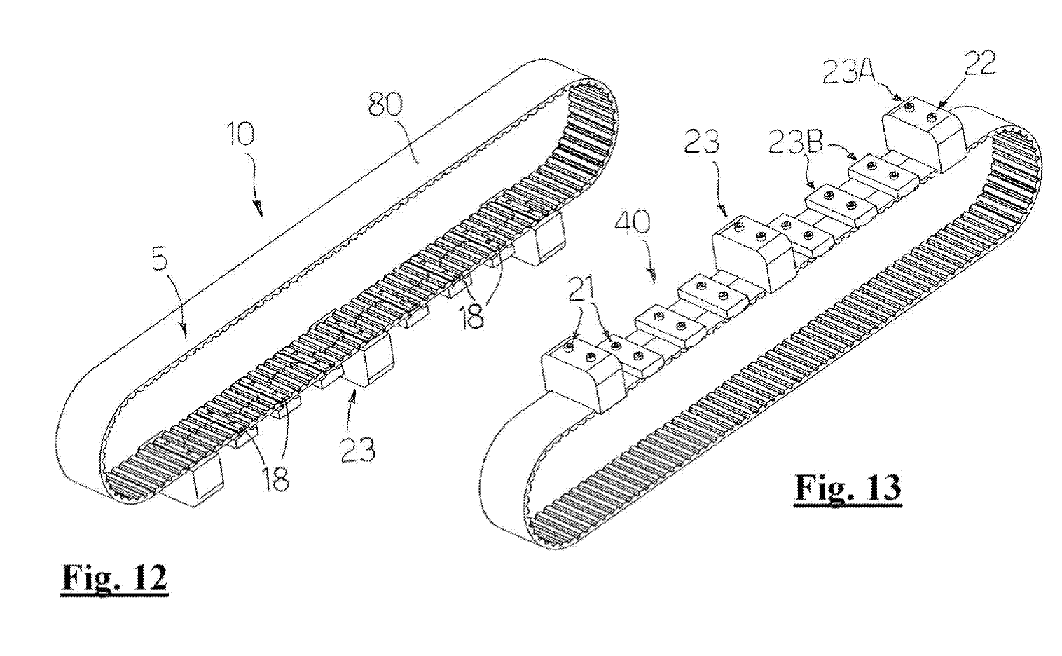

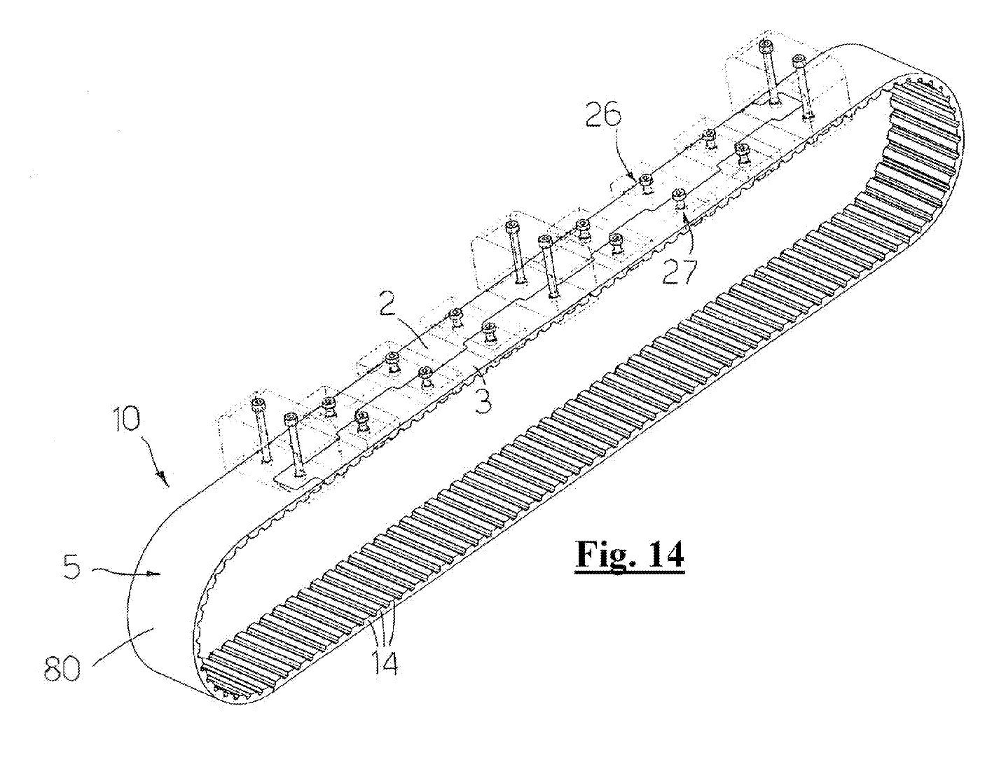

A variant of the above-described method comprises a different fixing mode of the ends 2, 3 by applying small blocks, according to the following steps:
removing the material of a certain number of teeth 14 of the looped belt 10, which are part of the restraining region 40 of the ends 2, 3, so that corresponding flattenings 15 are provided (FIG. 6);
providing two through holes 16, 17 in predetermined position in each flattening 15, one for each end 2, 3 (FIGS. 6, 7, 8);
applying a false tooth 18 at each flattening 15, so that two threaded holes 26, 27 made in the same false tooth 18 result respectively coaxial to the through holes 16, 17 made in the flattening 15 (FIGS. 9, 10);
applying a small block 23 at the side of the looped belt 10 opposite to the side in which each flattening 15 is provided, so that two through holes 31, 32 made in the small block 23 result coaxial to the through holes 16, 17 of the flattening 15 and to the threaded holes 26, 27 of the corresponding false tooth 18 (FIGS. 9, 10);
applying, from the side of the looped belt 10 opposite to the side in which the relative toothing is provided, threaded organs 21, 22 (in the shown example two hexagonal socket cheese-headed screws 21, 22) engaging each small block 23-false tooth 18 unit, in order to removably fix the mutually restrained ends 2, 3 (FIGS. 9, 10, 11, 12, 13, 14).

As it is known, a false tooth 18 is an element intended to function as a tooth 14 of the looped belt 10, when this one is wrapped around toothed gears.

The assembly of small block 23-false tooth 18 units, applied at the region 40 of the coupled ends 2, 3 of the toothed belt piece 1, determines the removable fixing of the same ends 2, 3; such units stabilize the restraining of the ends 2, 3, in particular in orthogonal direction to the extension surface S of the looped belt 10. This is needed to maintain the ends 2, 3 of the closed looped toothed belt piece 1 in a coupling configuration, when the piece is wrapped around the pulleys.

The resistance to the traction efforts of the looped belt 10 is instead mainly exerted by the ends 2, 3 being restrained, as above-precised, by means of the interaction of the contacting surfaces of the first 6 and second portions of complementary profiles 4, 5.

The assembly of small block 23-false tooth 18 units can be advantageously used also for the transport of articles; as a way of example, FIG. 19 shows a looped belt 10 which comprises small blocks 23 of different type. A first type of greater dimensioned small block is indicated with the reference number 23A; it is intended to allow the transport of an article (not indicated) and contributes to the removable fixing of the ends 2, 3 of the looped belt 10. A second type of small block 23B contributes instead only to the removable fixing of the ends 2, 3 of the looped belt 10. Yet referring to applications concerning the transport of articles, it is obviously possible to provide other small blocks of the type indicated with the reference number 23A along the longitudinal extension of the looped belt 10 (solution not shown in the figures), which have only the function of transporting corresponding articles and/or defining receiving seats thereof.

It is intended that small blocks of different type can be used for the removable fixing of the ends 2, 3 of the looped belt 10, as it is however clear to the expert in the art; it is for example possible to make use of solutions not using false teeth or solutions which, instead of the small block, are only provided with large headed screws, which are equally able to guarantee the removable fixing of the ends 2, 3 with respect to each other.

An advantage of the present invention is the realization of a belt piece which can be used for the transport of articles and/or for power transmissions, of the type which can be closed as a loop by means of restraining the respective ends, which belt piece is newly conceived and allows to obtain closed looped belts having improved features of resistance to traction efforts with respect to the known ones. Moreover, the thus obtained belt piece implies realization costs relatively low with respect to the advantages intended to be pursued.

The present invention is yet advantageous in that it offers a method for obtaining a closed looped belt starting form using a belt piece of new concept of the above-described type, which belt can be used for the transport of articles and/or for power transmissions and which has improved features of resistance to traction efforts with respect to the belts of known type. Moreover, the present method implementation implies relatively low costs with respect to the advantages intended to be pursued.

Therefore, the above-described advantages show how the belt piece and the method for obtaining a closed looped belt starting from the same belt piece, both object of the present invention, satisfy the prefixed aims and brilliantly solve the drawbacks pertaining to the known solutions.

Yet the present invention is advantageous in that it offers a belt piece which, depending on the traction/compression efforts the corresponding looped belt is to be subjected to, allows to design the shape and the longitudinal extension of the respective coupling ends 2, 3 according to applicative needs.

Yet the present invention is advantageous in that it offers a belt piece, which allows to obtain closed looped belts having improved features of resistance to transverse stresses as well, which are applied thereto.

It is intended that the preceding description is purely exemplary and not limiting, therefore possible practical changes or variations are clearly intended to fall in the protective scope of the invention, as above-described and defined by the following claims.

1. A belt piece which can be closed to obtain a closed loop for use in transporting articles or for transferring powers, comprising:
a central body (80) and two ends, a first end (2) and a second end (3), which can be connected to each other, said first and second ends (2, 3) being extendable in parallel to a longitudinal axis of said belt piece (1); said first and second ends having transverse dimensions smaller than transverse dimensions of the central body (80) of said belt piece (1); and at least at longitudinal sides (81, 82), the first and second ends (2, 3) have complementary coupling profiles (4, 5) respectively comprising at least a first portion and a second portion (6, 7), which contact each other when said ends (2, 3) are restrained with respect to each other such that the first and second portions press against each other when a longitudinal traction force is applied to said belt piece (1), closed as a loop, to prevent the first and second ends (2, 3) from sliding in the longitudinal direction.

2. Belt piece according to claim 1, characterized in that said complementary coupling profiles (4, 5) are also provided at transverse sides (83, 84, 85, 86) of said first and second ends (2, 3) and respectively comprise at least a third and a fourth portion (12, 13), which contact each other when said ends (2, 3) are restrained with respect to each other and press the one against the other in case a transverse stress is applied to said belt piece (1), closed as a loop, to prevent the same ends (2, 3) from sliding in said cross direction.

3. Belt piece according to claim 1, characterized in that the longitudinal extension of said first and second ends (2, 3) is a predetermined number of times greater than the transverse dimension of said belt piece (1).

4. Belt piece according to claim 1, characterized in that said complementary coupling profiles (4, 5) are dovetail-shaped.

5. A method for obtaining a closed looped belt, usable for the transport of articles and/or for power transmissions, the belt being made from a belt piece, characterized in that it comprises the steps of:
providing a belt piece comprising a central body (80) and two ends, a first end (2) and a second end (3), which can be connected to each other, said first and second ends (2, 3) being extendable in parallel to a longitudinal axis of said belt piece (1); said first and second ends having transverse dimensions smaller than transverse dimensions of the central body (80) of said belt piece (1); and at least at longitudinal sides (81, 82), the first and second ends (2, 3) have complementary coupling profiles (4, 5) respectively comprising at least a first portion and a second portion (6, 7), which contact each other when said ends (2, 3) are restrained with respect to each other such that the first and second portions press against each other when a longitudinal traction force is applied to said belt piece (1), closed as a loop, to prevent the first and second ends (2, 3) from sliding in the longitudinal direction;
approaching said ends (2, 3) of said belt piece (1) in a direction comprising at least one component orthogonal to the longitudinal direction of extension of said belt piece (1), until said ends (2, 3) of said belt piece (1) are restrained with respect to each other, so as to obtain a belt (10) closed as a loop;
and fixing said ends (2, 3) with respect to each other.

6. Method according to claim 5, characterized in that said approaching step of said ends (2, 3) and their subsequent restraining particularly provide:
approaching said ends (2, 3) of said belt piece (1) at different heights such that according to a plan view of said ends (2, 3) said complementary profiles (4, 5) match with respect to each other, and
approaching said ends (2, 3) of said belt piece (1) with respect to each other according to a direction orthogonal to the extension surface (S) of the same ends (2, 3) until these latter are restrained with respect to each other, so as to obtain said closed looped belt (10).

7. Method according to claim 5, of the type employing said belt piece (1) having said ends (2, 3) comprising thermoplastic material, characterized in that said fixing step of said ends (2, 3) with respect to each other occurs by local melting of the relative thermoplastic material.

8. Method according to claim 5, characterized in that said fixing step of said ends (2, 3) with respect to each other occurs by applying at least a small block (23) to the same ends (2, 3).

9. Method according to claim 5, of the type employing one said belt piece (1), characterized in that said fixing step of said ends (2, 3) with respect to each other occurs by means of the following steps:
removing the material of at least a tooth (14) which is part of the region (40) of said restraining of said ends (2, 3) with respect to each other so that it is provided a corresponding flattening (15);
providing at least two through holes (16, 17) in said flattening (15), one for each said end (2, 3);
applying a false tooth (18) at said flattening (15), so that two threaded holes (26, 27) made in said false tooth (18) result respectively coaxial to said through holes (16, 17) made in said flattening (15);
applying, from the side of said belt piece (1) opposite to the side in which the relative toothing is provided, threaded organs (21, 22) engaging said through holes (16, 17) and threaded holes (26, 27) with consequent clamping of said ends (2, 3) with respect to each other.

10. Method according to claim 9, characterized in that before said clamping step, it also provides the application of a small block (23) at the side opposite to the side of said belt piece (1) in which said flattening (15) is provided, so that through holes (31, 32) made in said small block (23) result coaxial to said through holes (16, 17) of said flattening (15) and to said threaded holes (26, 27) of said false tooth (18), so as to obtain a clamping of said ends (2, 3), having determined characteristics of stability.
